(19) United States
(12) Patent Application Publication
(10) Pub. No.: US 2026/0352050 A1
(43) Pub. Date: Nov. 5, 2026

(54) FLUID COOLING FOR WOUND ROTOR ASSEMBLY

(71) Applicant: American Axle & Manufacturing, Inc., Detroit, MI (US)

(72) Inventor: Christopher D. Pump, Macomb, MI (US)

(21) Appl. No.: 19/197,013

(22) Filed: May 2, 2025

(51) Int. Cl. H02K 1/32; H02K 1/24; H02K 3/30; H02K 3/32; H02K 7/00

(52) U.S. Cl. CPC H02K 1/32; H02K 1/24; H02K 3/30; H02K 3/325; H02K 7/003

(57) ABSTRACT

A rotor assembly used in an electric motor included with an electric drive unit for a battery electric vehicle has a rotor cage having a central bore and plurality of rotor slots defined between rotor posts; an output shaft received within the central bore of the rotor cage; a rotor winding wound around a rotor post and partially filling a rotor slot leaving a void space within the rotor slot; and one or more elongated rotor slot assemblies, positioned in the void space, having a fluid channel located adjacent an outer surface that abuts the rotor winding.

### TECHNICAL FIELD

The present application relates to rotating electrical machines and, more particularly, to rotor assemblies included with the rotating electrical machines.

### BACKGROUND

Vehicles increasingly rely on one or more electric motors to at least partially propel the vehicle, directly or indirectly. The performance and efficiency of the electric motors can greatly improve the functionality of the vehicle by increasing range or performance. A number of different aspects of the electric motor can be optimized to increase range or performance. For instance, the temperature at which the electric motor operates can be controlled to increase overall power output and the efficiency with which the electric motor uses electrical current supplied by a vehicle battery through an inverter.

### SUMMARY

In one implementation, a rotor assembly used in an electric motor included with an electric drive unit for a battery electric vehicle has a rotor cage having a central bore and plurality of rotor slots defined between rotor posts; an output shaft received within the central bore of the rotor cage; a rotor winding wound around a rotor post and partially filling a rotor slot leaving a void space within the rotor slot; and one or more elongated rotor slot assemblies, positioned in the void space, having a fluid channel located adjacent an outer surface that abuts the rotor winding.

In another implementation, a rotor assembly used in an electric motor included with an electric drive unit for a battery electric vehicle has a rotor cage having a central bore and plurality of rotor slots defined between rotor posts; a first end cap, including a fluid supply pathway, coupled to an end of the rotor cage; a second end cap, including a drain, coupled to an opposite end of the rotor cage; an output shaft, received within the central bore of the rotor cage, having a fluid cavity configured to receive fluid from a fluid source and communicate fluid with the fluid supply pathway and the drain; a rotor winding wound around a rotor post and partially filling a rotor slot leaving a void space within the rotor slot; and one or more elongated rotor slot assemblies, positioned in the void space, having a fluid channel located adjacent an outer surface that abuts the rotor winding.

### BRIEF DESCRIPTION OF THE DRAWINGS

FIG. 1 is a perspective view depicting an implementation of an rotor assembly used in an electric motor included with an electric drive unit for a battery electric vehicle;

FIG. 2 is a cross-sectional view depicting an implementation of an rotor assembly used in an electric motor included with an electric drive unit for a battery electric vehicle;

FIG. 3 is a cross-sectional view depicting a portion of an implementation of a rotor assembly used in an electric motor included with an electric drive unit for a battery electric vehicle;

FIG. 4 is a cross-sectional view depicting a portion of an implementation of a rotor assembly used in an electric motor included with an electric drive unit for a battery electric vehicle; and

FIG. 5 is a cross-sectional view depicting a portion of an implementation of a rotor assembly used in an electric motor included with an electric drive unit for a battery electric vehicle.

### DETAILED DESCRIPTION

An electric drive unit for a vehicle can have a rotating electrical machine (also referred to as an electric motor) that includes a stator assembly having stator windings electrically coupled to an inverter and a rotor assembly having rotor slots that receive rotor windings. The rotor windings can be wound around rotor teeth that extend radially outwardly from a motor axis as well as axially parallel to the motor axis. The rotor teeth can define rotor slots within which the rotor windings are positioned after winding. Regardless of the winding technique used to wind the rotor windings around the rotor teeth, the rotor slots will include some void space that is not occupied by rotor windings. One or more elongated rotor slot assemblies can be positioned into the unoccupied portion of the rotor slot so that the assemblies abut an external surface of the rotor windings and include fluid pathways positioned adjacent to an outer surface of the assemblies that abut the rotor windings. The rotor assembly can be carried about an output shaft having at least one fluid channel that receives cooling fluid from a fluid source and is in fluid communication with the elongated rotor slot assemblies to pass the cooling fluid through the elongated rotor slot assemblies and reduce the temperature of the rotor windings.

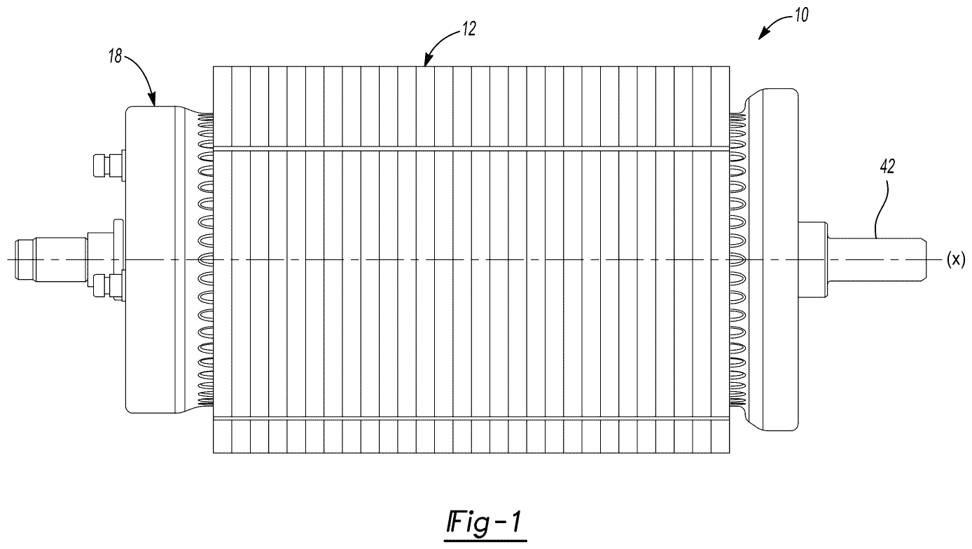

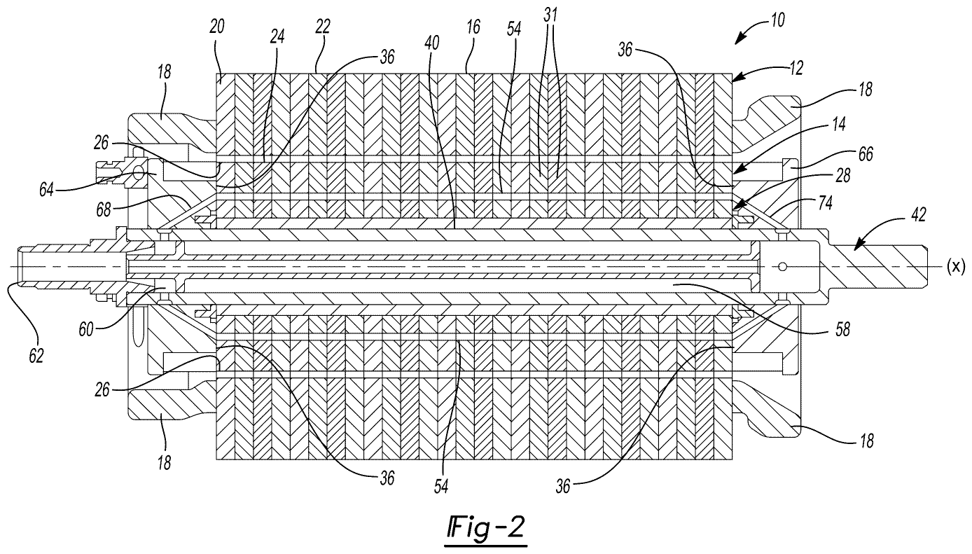

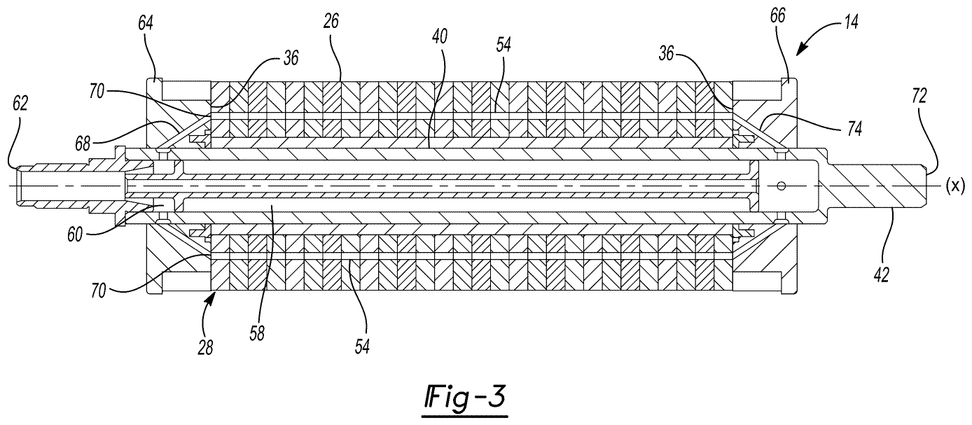

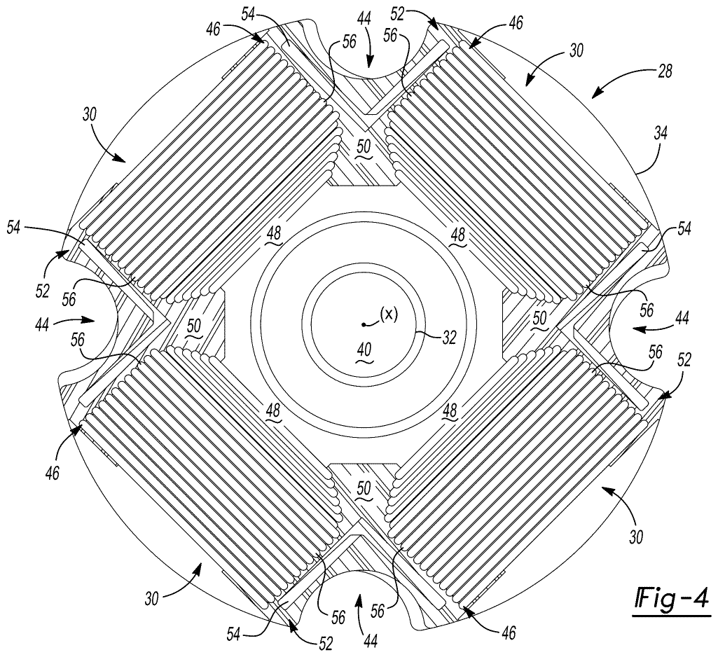

Turning to FIGS. 1-5, an implementation of a rotating electrical machine 10 (also referred to as an electric motor) capable of use with an electric drive unit (EDU) that at least partially provides propulsion to a battery electric vehicle (BEV) is shown in FIG. 1. In addition to the electric motor 10, the EDU can include a battery, a control system with an inverter that inverts DC voltage stored in the battery, and a busbar assembly that electrically couples the control system/inverter to stator windings of the electric motor 10. The term “battery electric vehicle” or “BEV” can refer to vehicles that are propelled, either wholly or partially, by rotating electrical machines or electric motors. BEV can refer to electric vehicles, plug-in electric vehicles, hybrid-electric vehicles, fuel cell vehicles, range-extended electric vehicles, and battery-powered vehicles. The term vehicle should be broadly construed to include a variety of transportation modes, not limited to automobiles.

The electric motor 10 can include a stator assembly 12 and a rotor assembly 14 that is rotatable relative to the stator assembly 12 about a motor axis (x). The control system/inverter can convert the DC electrical power received from the battery into AC electrical power to induce angular movement of the rotor relative to the stator. The control system/inverter can include a plurality of switches, such as MOSFETs, that are arranged in electrical communication with the busbar assembly and the electric motor 10 such that the arrangement of switches have gate inputs electrically connected to a microprocessor or microcontroller that selectively renders the switches conductive to induce the rotor assembly to rotate relative to the stator assembly. The battery or batteries are rechargeable and can include lead-acid batteries, nickel cadmium (NiCd), nickel metal hydride, lithium-ion, and lithium polymer batteries, to name a few. A typical range of BEV battery voltages can range from 200 to 800V of DC electrical power (VDC). An example of an electric drive unit (sometimes referred to as an electric drive module) is described in U.S. Pat. No. 11,303,183 the contents of which are incorporated by reference in their entirety.

The stator assembly 12 includes a stator 16 having stator teeth (not shown) that receive stator windings 18 that are electrically connected to the busbar assembly. The stator 16 can be formed from a plurality of stamped iron plates 20 that each include stator slots for receiving the stator windings 16. The stamped iron plates 20 can be axially stacked along the motor axis (x) and bonded together to form a unitary structure capable of receiving the stator windings 16. The stator assembly 12 can be substantially tubular in shape having an outer diameter 22 and an inner diameter 24. The rotor assembly 14 can be concentrically received within the inner diameter 24 of the stator assembly 12 such that an outer diameter 26 of the rotor assembly 14 closely faces the inner diameter 24 of the stator assembly 12 such that the flow of electrical current through the stator windings 16 can induce the rotor assembly 14 to rotate about the motor axis (x) such that the rotor assembly 14 is angularly displaced relative to the stator assembly 12.

The rotor assembly 14 includes a rotor cage 28 having a plurality of rotor teeth 30 that extend radially outwardly away from the motor axis (x) as well as axially along the motor axis (x). The rotor cage 28 can exist as a substantially cylindrical structure having an inner diameter 32 and an outer diameter 34 with end surfaces 36 that can couple with end caps 64, 66. The outer diameter 34 of the rotor cage 28 can face the inner diameter 24 of the stator assembly 12; the inner diameter 32 of the rotor cage 28 can include a central bore 40 sized to receive an output shaft 42. The rotor teeth 30 of the rotor cage 28 can be angularly spaced around the motor axis (x) such that the rotor teeth 30 define rotor slots 44 within which rotor windings 46 can be positioned. In one implementation, each rotor tooth 30 can have a post 48 that supports the rotor winding 46, formed from an electrically-conductive wire that has a substantially circular cross section, wound around the post 48 using a concentrated winding technique. However, it should be appreciated that other winding techniques and cross-sectional shapes could be used to create the rotor windings. The rotor cage 28 can be formed from a plurality of stamped iron plates 31 that each include an outer contour that is shaped to form rotor teeth for receiving the rotor windings 46. The stamped iron plates 31 can be axially stacked along the motor axis (x) and bonded together to form a unitary structure capable of received and supporting the rotor windings as well as withstanding the angular velocities at which the rotor assembly 14 rotates.

After a rotor winding 46 is wound around each rotor tooth 30, the rotor winding 46 is positioned within a portion of the rotor slot 44. Each rotor slot 44 can receive rotor windings 46 from angularly adjacent rotor teeth 30. After the rotor windings 46 are wound around the rotor teeth 30, the shape and position of the rotor winding 46 is such that rotor windings 46 of angularly adjacent rotor teeth 30 do not fully occupy all of the space of the rotor slot 44. A void space 50 can exist in the rotor slot 44 by virtue of a slot fill of the rotor winding 46 that is less than 100 percent such that a portion of the rotor slot 44 is not occupied by rotor windings 46. The size and the shape of the void space 50 can vary depending on the winding techniques used to wind the rotor windings 46 around the rotor teeth 30.

One or more elongated rotor slot assemblies 52 can be positioned within the void space 50 in the rotor slots 44 and have fluid channels 54 positioned near an outer surface 56 of the assemblies 52 that abuts the rotor windings 46. The outer surface 56 of the elongated rotor slot assemblies 52 can be shaped such that when positioned within the rotor slot 44 the outer surface 56 abuts the rotor windings 46. In one implementation, the elongated rotor slot assemblies 52 can extend the length of the rotor cage 28 and be formed from a non-electrically conductive material that also is thermally conductive. The elongated rotor slot assemblies 52 can include at least one fluid channel 54 that is positioned within the assemblies to be as close as possible to the outer surface 56 that abuts the rotor windings 46. The fluid channels 54 can have a substantially planar cross section with a width that is equal to or greater than the area of the outer surface the rotor windings contact. The elongated rotor slot assemblies 52 can be constructed or otherwise formed in one of a number of different ways. For instance, the elongated rotor slot assemblies 52 can be formed as individual assemblies apart from the rotor cage 28 such that, after the rotor windings 46 are added to the rotor cage 28, the individually-formed elongated slot assemblies 52 can be combined with the rotor assembly 14 and positioned in the void space 50. The individually-formed elongated rotor slot assemblies 52 can be anchored in place with some potting compound or non-electrically-conductive adhesive. Other implementations are possible in which the elongated rotor slot assemblies 52 are formed in-situ within the void space 50 after the rotor windings are wound around each rotor tooth 30 and positioned within the rotor slot 44. The elongated slot assemblies 52 formed in-site can be formed from an elastomeric material that is injection molded into rotor cages 28 having rotor windings 46. It is possible to include tooling removably positioned within the void space 50 to create fluid channels within the elongated slot assemblies 52.

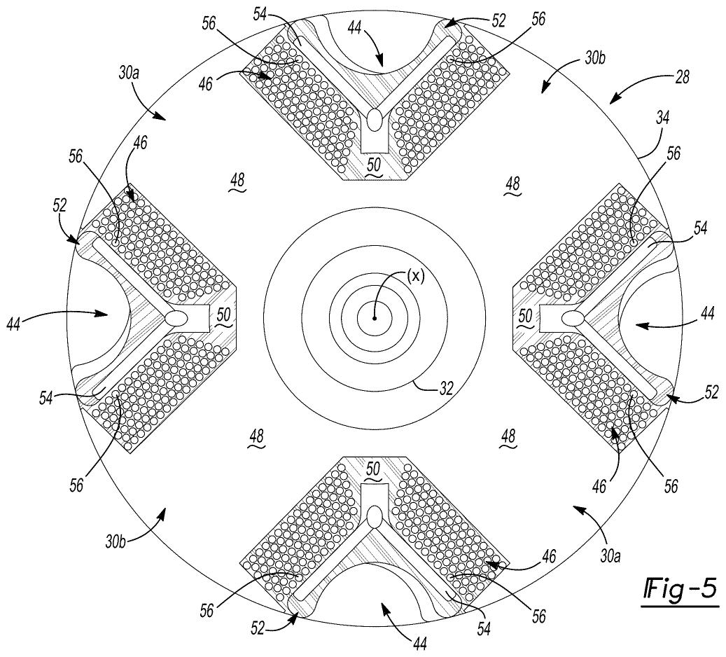

In one implementation a single fluid channel 54 can be positioned adjacent an outer surface 56a of the elongated rotor slot assembly 52 that abuts a rotor winding 46 on a first rotor tooth 30a as well as an outer surface 56b of the elongated rotor slot assembly 52 that abuts a rotor winding on a second rotor tooth 30b as shown in FIG. 5. For example, the single fluid channel 54 may have a substantially V-shaped cross section that carries fluid to rotor windings 46 on adjacent rotor teeth 30.

The output shaft 42 can be received within an inner diameter 32 of the rotor cage 28 such that the output shaft 42 and rotor cage 28 are fixed together to prevent the angular displacement of the output shaft 42 relative to the rotor cage 28. The output shaft 42 can communicate rotational motion of the rotor assembly 14 to an input, such as a transmission of a BEV (not shown). In addition, the output shaft 42 can communicate cooling fluid from a fluid source into the stator assembly 12 and the rotor assembly 14 for cooling the electric motor 10. The output shaft 42 can include a fluid cavity 58 that extends the axial length of the output shaft 42. A fluid manifold 60 can be positioned at a proximate end 62 of the output shaft 42 to receive the cooling fluid and direct the cooling fluid to a first end cap 64 of the rotor cage 28. The first end cap 64 can couple to an axial end of the rotor cage 28. A second end cap 66 can couple to an opposite axial end of the rotor cage 28. The end caps 64, 66 can be added to help balance the rotor assembly 14 as well as communicate fluid within the rotor assembly 14. The fluid manifold 60 can supply cooling fluid to a fluid supply pathway 68 positioned within the first end cap 64 that provides the fluid to an open end 70 of the fluid channels 54 of the elongated rotor slot assemblies 52. The cooling fluid can flow axially through the fluid channels 54 toward a distal end 72 of the output shaft 42 where the fluid reaches the second end cap 66. The second end cap 66 can include a drain 74 that communicates fluid into the fluid cavity 58 of the output shaft 42 and returns the cooling fluid to the proximate end 62 of the output shaft 42. In some implementations, a plurality of fluid channels 54 can be included in the elongated rotor slot assemblies 52 extending along the motor axis (x). The plurality of fluid channels 54 can be individually sized such that one fluid channel that is closest to the rotor winding 46 may have a cross-sectional area that is larger than an adjacent fluid channel 54 such that an asymmetrical amount of fluid flows through adjacent fluid channels 54.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A rotor assembly used in an electric motor included with an electric drive unit for a battery electric vehicle, comprising:
a rotor cage having a central bore and plurality of rotor slots defined between rotor posts;
an output shaft received within the central bore of the rotor cage;
a rotor winding wound around a rotor post and partially filling a rotor slot leaving a void space within the rotor slot; and
one or more elongated rotor slot assemblies, positioned in the void space, having a fluid channel located adjacent an outer surface that abuts the rotor winding.

2. The rotor assembly recited in claim 1, wherein the fluid channel is positioned adjacent another rotor winding wound around another rotor post.

3. The rotor assembly recited in claim 1, wherein the output shaft includes a fluid cavity in fluid communication with the one or more elongated rotor slot assemblies.

4. The rotor assembly recited in claim 1, wherein the fluid channel has a V-shaped cross section.

5. The rotor assembly recited in claim 1, wherein the fluid channel has a planar shape.

6. The rotor assembly recited in claim 1, further comprising a first end cap, coupled to an end of the rotor cage, having a fluid supply pathway providing fluid to the fluid channel and second end cap, coupled to an opposite end of the rotor cage, including a drain that receives fluid from the fluid channel.

7. The rotor assembly recited in claim 1, wherein the one or more elongated slot assemblies are formed from an electrically insulating and thermally conducting material.

8. The rotor assembly recited in claim 1, wherein the one or more elongated rotor slot assemblies comprises an elastomeric material formed in situ after the rotor winding is wound around the rotor post.

9. A rotor assembly used in an electric motor included with an electric drive unit for a battery electric vehicle, comprising:
a rotor cage having a central bore and plurality of rotor slots defined between rotor posts;
a first end cap, including a fluid supply pathway, coupled to an end of the rotor cage;
a second end cap, including a drain, coupled to an opposite end of the rotor cage;
an output shaft, received within the central bore of the rotor cage, having a fluid cavity configured to receive fluid from a fluid source and communicate fluid with the fluid supply pathway and the drain;
a rotor winding wound around a rotor post and partially filling a rotor slot leaving a void space within the rotor slot; and
one or more elongated rotor slot assemblies, positioned in the void space, having a fluid channel located adjacent an outer surface that abuts the rotor winding.

10. The rotor assembly recited in claim 9, wherein the fluid channel is positioned adjacent another rotor winding wound around another rotor post.

11. The rotor assembly recited in claim 9, wherein the fluid channel has a V-shaped cross section.

12. The rotor assembly recited in claim 9, wherein the fluid channel has a planar shape.

13. The rotor assembly recited in claim 9, wherein the one or more elongated slot assemblies are formed from an electrically insulating and thermally conducting material.

14. The rotor assembly recited in claim 9, wherein the one or more elongated rotor slot assemblies comprises an elastomeric material formed in situ after the rotor winding is wound around the rotor post.
